(19) United States
(12) Patent Application Publication
(10) Pub. No.: US 2010/0180038 A1
(43) Pub. Date: Jul. 15, 2010

(54) METHOD FOR PROVIDING A COMPUTER PROGRAM TO A MOBILE COMPUTERISED DEVICE AND A PORTABLE ELECTRONIC APPARATUS FOR STORING THE COMPUTER PROGRAM

(75) Inventor: Oyvind HORPESTAD, Haugesund (NO)

Correspondence Address: VOLPE AND KOENIG, P.C., UNITED PLAZA, SUITE 1600, 30 SOUTH 17TH STREET, PHILADELPHIA, PA, 19103, US

(73) Assignee: ADVANCED MOBILE TECHNOLOGY A/S, Copenhagen V (DK)

(21) Appl. No.: 12/354,380

(22) Filed: Jan. 15, 2009

(51) Int. Cl. G06F 15/16

(52) U.S. Cl. 709/228; 709/227

(57) ABSTRACT

A method is provided that provides computer data or a computer data program to a mobile computerised device. The computer data or computer program being stored on a portable electronic apparatus and is able to operate the mobile computerised device to provide an information or service. The portable electronic apparatus includes a memory device for storing the computer data or computer program, a further memory device for storing usage information and a more further memory device for storing information of the mobile computerised device obtained from the mobile computerised device, said portable electronic apparatus having at least one interface and at least one data communication device for communicating with the mobile computerised device. The interface and the communication device communicating under the control of a controller including data programs for initiating, controlling and terminating the communication. The portable electronic apparatus includes a display device for displaying messages.

### FIELD OF INVENTION

The present invention relates to a method for providing computer data program to a mobile computerised device. The computer program is stored on a portable electronic apparatus and is able to operate the mobile computerised device to provide an information or service that is different from a standard information or service of the device. The portable electronic apparatus has a memory device for storing the computer program, a further memory device for storing usage information and a more further memory device for storing information of the mobile computerised device obtained from same device. The portable electronic apparatus has an interface and a data communication device for communicating with the mobile computerised device and the interface and communication device is communicating under the control of a controller having programs for initiating, controlling and terminating the communication. Furthermore, the portable electronic apparatus has a display device for displaying messages to a user.

### BACKGROUND

It is well known in today's use of computerised devices like mobile phones, personal digital assistants or the like that the processing power of these devices has increased to a degree to which the devices have become capable of performing various tasks which a few years ago were only possible in computers. For instance, mobile phones can be used for installing and playing games or function as a device for playing music to the user via headphones or they can be configured for access to the Internet. As a consequence thereof, it is necessary to transfer configuration profiles or content such as music, games or new applications to the device from an external source. Due to expanding use, a growing demand for the installation of for instance virus detection and removal software is evident.

The transfer of these data, configuration data and the like has been made in a number of different ways. One approach is connect to a personal computer via a serial gate, a USB port, ldDA and/or Bluetooth interface. Prior to this, the personal computer has been loaded with the relevant data or content from a storage device or it may have been downloaded from the Internet. Another approach is to provide the data content and applications to a mobile device using Over The Air (OTA) techniques such as SMS or WAP.

Yet another approach is illustrated in WO2005/069117 A1, where the configuration data or applications is stored in a small portable electronic apparatus, which is connected to the mobile device via a standard serial interface.

### SUMMARY

On the market for handheld devices today, whether it is mobile phones, PDAs, smartphones or the like, there is a great variety of manufactured products, and each manufacturer has a number of different models. Among these models, there are differences in the ways in which content can be downloaded, depending on the capabilities of the mobile device. Due to the difference in capabilities (such as processor speed, screen size, memory size and the like and/or support for software) and the operating system between the models, the downloaded content and applications can vary significantly among different manufactured products, but also among models by the same manufacturer. Identifying the correct content file or application for specific model can be complicated.

The transfer of configuration data or content can be carried out by use of specialised AT commands that will prompt specific configuration profiles in the mobile device or standard AT commands that can simulate keystrokes on the mobile device. Another way would be to store the configuration data or content in a standard format like XML and subsequently transfer the data using standard data transfer methods. A disadvantage is that since not all data or content transfer methods are available in all mobile devices, it is necessary for the user to choose the correct way of transferring data to the mobile device, which for most users will be a demanding task. Furthermore, some of the different transfer methods requires some technical knowledge and effort and can be cumbersome.

The object of the invention is therefore to facilitate an automatic choice of the correct way of downloading the data or content to the mobile device with little or no user interference.

The method according to the invention is characterized by the features as stated in claim 1, which enables the electronic apparatus that is connected to the mobile device to ascertain the correct way of transferring data or other content to the mobile device.

Furthermore, the method according to the invention includes steps of the apparatus for storing the information gathered from the mobile device. This information is a unique identification number and a device class identifier converted to an electronic, storable format. The information stored may be used for prohibiting transfer of data to other mobile devices with identification numbers and/or class identifiers that differs from the stored information.

The decision of the correct way of communicating with the mobile device can according to the invention be performed by a decision algorithm that is stored in a memory device in the apparatus, said steps being performed by the controller.

According to the invention it is furthermore possible that the user of the portable electronic apparatus can be prompted via a display device to perform an action at a stage in the transfer process. For instance, the user can manually accept the installation and/or activation of the data.

One way of transferring data, content or the like between the apparatus and the mobile device is according to the invention, by sending standard AT commands to the mobile device and having each AT command simulate a keystroke or represent one character, thus getting the correct configuration installed on the device.

Another way of transferring data is according to the invention by sending specialised AT commands that are specific for the mobile device, said specialised AT commands representing special configurations profiles.

Further according to the invention, the configuration data or content that is stored in the apparatus in a standardised format, such as XML or the like, can be transferred to the mobile device and stored there in a storage device and subsequently be activated either automatically or by user intervention.

Another way of transferring configuration data or content to the mobile device may according to the invention be to prompt the mobile device to send a Short Message Service (SMS) to a server holding the configuration data or content to be transferred. Hereafter, the server replies by sending the configuration data or content to the mobile device as an SMS, an MMS or using other standardised methods for sending data over wireless connections. The configuration data may subsequently be installed on the mobile device automatically or by user intervention.

Furthermore, the invention relates to an apparatus, comprising a memory device for storing the data or content and a memory device for storing user data and information of the mobile device, such as model number and a unique identification code or the like. The apparatus has an interface, which can be electronic or wireless or use any other standard way of connecting to a mobile device. This interface is used when connecting to the mobile device to which the data or content shall be transferred. A controller for controlling the apparatus is supplied, which can store and execute program data holding the algorithms for storing and transferring data. This data program is also used for enabling user intervention or for making the necessary decisions regarding storing of data and transfer of data or content. A communication device for controlling the communication with the attached mobile device is also present, either a separate entity connected to the controller or as an integrated part of the controller. To enable the apparatus for prompting user intervention or for giving information of the status of the apparatus or the status of the transfer of data or content, a display device is supplied on the apparatus together with one or more buttons to be used for user interaction.

The apparatus is for instance formed as a box roughly the size of a standard matchbox, as this is a sufficient size for the user to interact comfortably with the buttons and the display device, while at the same time facilitating an easy storing and transport for the individual user.

### BRIEF DESCRIPTION OF THE DRAWINGS

The invention is explained in detail below with reference to the drawings, in which

FIG. 1 is a simplified schematic drawing of the portable apparatus,

FIGS. 2a and 2b, taken together, is a flowchart of the process for starting the transfer of data between the portable apparatus holding the data and the mobile device, and

FIG. 3 is a depiction of the device

### DETAILED DESCRIPTION OF THE PREFERRED EMBODIMENT(S)

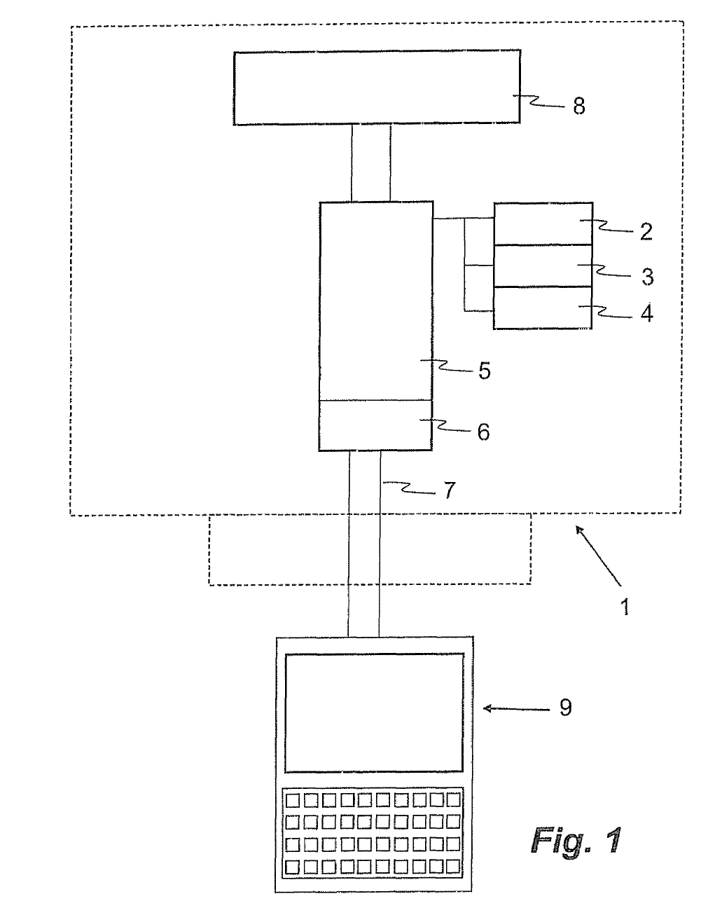

This is a description of a portable electronic apparatus 1 as depicted in FIG. 1, which is the holder of the data or content to be downloaded to a mobile device 9. The method as described may just as well be applied to stationary personal computers or other devices that can hold data and be connected to mobile devices.

When the apparatus 1 holding the data or content is connected to the mobile device 9 to which the data shall be transferred, and a connection is thus established via an interface 7, a process is performed in the portable apparatus 1. This process shall ascertain the class identifier, a possible unique identifier of the mobile device 1 and decide on a way to transfer the data from the portable apparatus 1 to the mobile device 9. The portable apparatus 1 has a memory device 2 for storing the data, content or the like and the control data program containing the algorithms controlling the portable apparatus 1, a further memory device 3 for storing user information and a more further memory device 4 for storing information of the mobile device that is connected via the interface 7.

The memory devices may be provided as one single memory device, where the data content or the like, user information and mobile device information is stored in separate areas.

In some embodiments, it may be part of the memory structure of the controller. The memory devices 2, 3 and 4 are connected to a controller 5, where a data program for controlling the apparatus 5 is stored and executed. The controller 5 is further connected to the display 8 of the apparatus 1, which may be used for presenting the status of the apparatus 1 to the user, the class identifier, or prompt the user to manual intervention or the like. The controller 5 further has a data communication device 6 for communicating with the attached mobile device 9 via the interface 7. The data communication device may be part of the controller 5, but may be implemented as a separate entity in some embodiments. In some embodiments the mobile device can have more than one interface and data communication device.

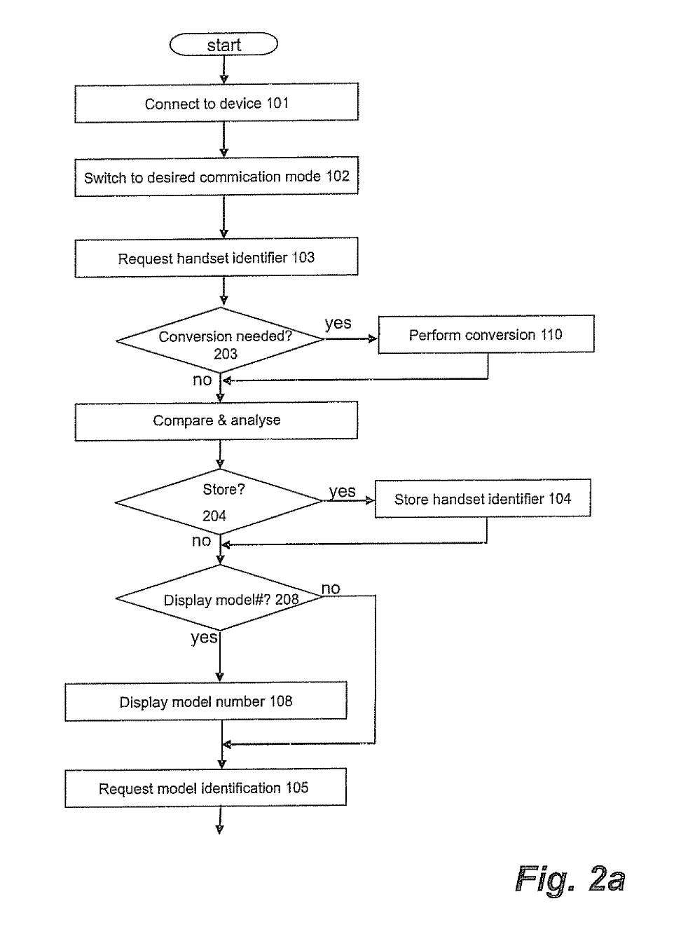

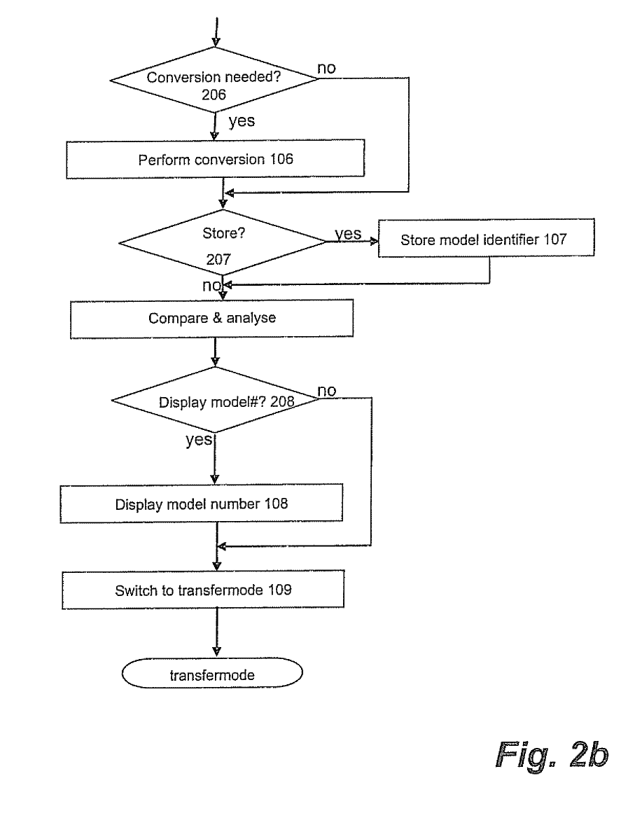

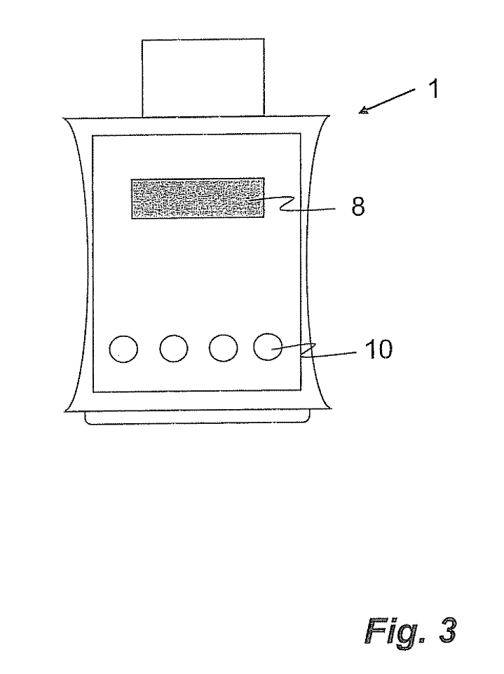

The process is initiated by starting an algorithm stored in the memory device 2 of the portable apparatus. This algorithm is started when the controller 5 of the apparatus 1 detects activity on the relevant data leads on the interface 7, whereupon the apparatus 1 is ready for communication in step 101, as illustrated in FIG. 2.

Hereafter, a step is performed in step 102, in which the communication mode between the apparatus 1 and the mobile device 9 is established. This can be achieved by the apparatus as it transmits commands over the interface 7 supposing one mode of communication. If no response is received or the response is unintelligible, the apparatus 1 transmits commands again, but supposing another mode of communication. When the communication is established a request is transmitted to the mobile device 9, requesting an identifier, which is unique for the device 9. This is step 103. This identifier is stored in different formats in the many different brands and models of mobile devices. Therefore, a conversion of the identifier may be necessary to bring the identifier into standardised format. In step 203, a test is performed to indicate if the number is on a standardised format or if it must be converted. If a conversion is needed this takes place in step 110.

Upon receipt of the unique identifier from the mobile device 9, the apparatus 1 will decide whether to store the obtained identifier in step 204. The decision can be performed automatically by the algorithm or it can be obtained by prompting a user intervention via display device 8 of the portable apparatus 1. If the user is prompted, the portable apparatus 1 enters into a waiting mode until the user again activates the algorithm. This can be done either via a dedicated button 10 or via a keyboard. If the identifier has to be stored, this will be done in step 104 using a memory device 4 of the portable apparatus 1. If the storing of the identifier is undesired, step 104 is skipped and the portable apparatus 1 via the interface 7 in step 105 issues a request for model number of the device 9. This model number is stored in different formats in the many different brands and models of mobile devices. Therefore, a conversion of the class identifier may be necessary to bring the class identifier into standardised format. In step 206, a test is performed to indicate if the number is on a standardised format or if it has to be converted, in which case a conversion must be performed in step 106 to convert the class identifier into a standardised format, common for all mobile devices.

When the conversion is performed a decision is taken in step 207 whether or not to store this class identifier. The decision can be performed automatically by the algorithm or it can be obtained by prompting a user intervention via the display device 8 of the portable apparatus 1. If the class identifier has to be stored, this will be carried out in step 107 using the memory device 4 of the portable apparatus 1, otherwise step 107 is skipped. In some situations, depending on the data or content to be downloaded, it may be desirable to display this class identifier on the display device 8 of the portable apparatus 1. If the class identifier should be displayed, a decision is taken in step 208. The displaying is done in step 108, depending on this decision. Finally, the portable apparatus 1 switches into the desired communication mode which should be used for transferring the configuration data or content to the mobile device 9.

Further, the application and use of the method can be illustrated by two additional embodiments. All embodiments use the “Compare & Analyse” blocks.

1) The case where a handset identifier is retrieved from computerised device and analysed and compared:
a) Configuration of software is such that device can only be used with N hand sets, and software this is the N+1 attempt to connect; or
b) Configuration of software is such that only pre-determined handset identifiers (stored already on the device memory) are allowed to proceed, and the attempted connection is made by a computerised device having different identifier than those stored.

In this case, the sequence will be terminated by “STOP” point after “Analyse & Compare”, e.g. before decision point (204).

2) The case where a class identifier is retrieved from computerised device and analysed and compared:
a) An invalid class is returned; or
b) A class for which the device is not configured; or
c) Configuration of software is such that only pre-determined class identifiers (stored already on the device memory) are allowed to proceed, and the at-tempted connection is made by a computerised device having different class than those stored.

In this case, the sequence will be terminated by “STOP” point after “Analyse & Compare”, e.g. before decision point (204).

What is claimed is:

1. A method for providing computer data or a computer data program to a mobile computerised device (9), said computer data or computer program being stored on a portable electronic apparatus (1) and is able to operate the mobile computerised device (9) to provide an information or service that is different from a standard information or service of said device (9), said portable electronic apparatus (1) having a memory device (2) for storing said computer data or computer program, a further memory device (3) for storing usage information and a more further memory device (4) for storing information of the mobile computerized device obtained from the mobile computerized device (9), said portable electronic apparatus (1) having at least one interface (7) and at least one data communication device (6) for communicating with the mobile computerised device (9), said interface (7) and said communication device (6) communicating under the control of a controller (5) including data programs for initiating, controlling and terminating the communication, and said portable electronic apparatus (1) having a display device (8) for displaying messages to a user, said method comprising:
a step in which the communication between the mobile computerized device (9) and the portable electronic apparatus (1) is initiated by connecting the portable electronic apparatus (1) and the mobile computerised device (9) and the controller (5) sensing the presence of the mobile computerised device (9) on the interface (7);
a step in which the controller of the portable electronic apparatus (1) decides on the mode of transferring data between the portable computerized device (9) and the portable electronic apparatus (1);
a step in which a request for an electronic representation of identity is sent from the portable electronic apparatus (1) to the mobile computerized device (9) and the electronic representation is transferred to the portable electronic apparatus (1);
a step in which a request for a model number is sent from the portable electronic apparatus (1) to the mobile computerised device (9) and the model number is transferred to the portable electronic apparatus (1);
a step in which the computer data or computer program stored in the memory device (2) of the portable electronic apparatus is transferred to the mobile computerised device.

2. Method according to claim 1 comprising:
a step in which the electronic representation of identity is converted from the representation used in the mobile computerised device (9) in a format that can be stored in the portable electronic apparatus (1),
a step in which the obtained model number is converted from the representation used in the mobile computerised device (9) to a format that can be stored in the portable electronic apparatus (1),
a step in which the electronic representation of the converted model number is stored in the memory device (4) of the portable electronic apparatus (1),
a step in which the class identifier is stored in the memory device (4) of the portable apparatus (1) and
a step in which the converted class identifier is displayed on the display device (8) of the portable electronic apparatus (1);
where each of the above steps are optional.

3. Method according to claim 1, wherein the decision of communication method by the controller (5) of the portable electronic apparatus (1) can be performed by a decision algorithm stored in the memory device (2).

4. Method according to claim 1, wherein the decision of communication method is performed by the user.

5. Method according to claim 1, wherein the transfer of data between the portable apparatus (1) and the mobile computerised device (9) is performed by the use of standard AT commands for transferring the data character by character.

6. Method according to claim 1, wherein the transfer of data between the portable electronic apparatus (1) and the mobile computerised device (9) is performed by the use of specialised AT commands.

7. Method according to claim 1, wherein the transfer of data between the portable electronic apparatus (1) and the mobile computerised device (9) is performed by transferring the data in standard formatted files.

8. Method according to claim 1, wherein the transfer of data between the portable electronic apparatus (1) and the mobile computerised device (9) is performed via Short Message System (SMS) messages.

9. A portable electronic apparatus (1) for providing computer data or a computer data program to a mobile computerised device (9), said computer data or computer program being stored on the portable electronic apparatus (1) and is able to operate the mobile computerised device (9) to provide an information or service that is different from a standard information or service of said computerised device (9), said portable electronic apparatus (1) comprising:
a memory device (2) for storing said computer data or computer program,
a further memory device (3) for storing usage information,
a more further memory device (4) for storing information of the mobile computerised device (9) obtained from the mobile computerised device (9),
a controller (5) having data programs for initiating, controlling and terminating the communication between the portable apparatus (1) and the computerised device (9)
at least one interface (7) for establishing contact with the mobile computerised device (9) by way of a mechanical, electrical or wireless connection
at least one data communication device (6) for communicating with the mobile computerised device (9),
a display device (8) for displaying messages to a user,
wherein the controller (5) is connected to the memory device (2, 3, 4), the data communication device (6) and the display device (8).

10. An apparatus according to claim 9, wherein the communication device (6) is integrated in the controller (5).
